(19) United States
(12) Patent Application Publication
(10) Pub. No.: US 2025/0166033 A1
(43) Pub. Date: May 22, 2025

(54) Method and System for Online Marketplace Facilitating Dynamic Resale of Event Tickets

(71) Applicant: Martin A. Negron-Moreno, Annapolis, MD (US)

(72) Inventor: Martin A. Negron-Moreno, Annapolis, MD (US)

(21) Appl. No.: 18/515,460

(22) Filed: Nov. 21, 2023

(51) Int. Cl. G06Q 30/0601

(52) U.S. Cl. CPC G06Q 30/0619; G06Q 30/0641

(57) ABSTRACT

The present invention provides a method and system for an online marketplace designed for the resale of event tickets. This method includes the operation of a computer server managing an accessible online platform, featuring an interactive event venue map segmented into sections and rows. It enables sellers to list tickets with desired prices and buyers to submit purchase offers for specific rows or entire sections, without the need for exact seat identification. Secure transactions are facilitated through an integrated escrow service, and the platform provides sorting and filtering functions to organize listings and offers.

### FIELD OF INVENTION

The present invention generally to computer-implemented systems for electronic commerce, specifically to methods and systems for facilitating the resale of event tickets through an online marketplace with dynamic pricing and secure transaction features.

### BACKGROUND

The contemporary landscape of online ticket resale for events, a domain marked by significant activity and demand, reveals an array of limitations and challenges inherent in existing systems. Traditionally, these platforms operate on a simplistic model where sellers list tickets for a fixed price, often with limited flexibility in pricing strategy and without the nuanced understanding of real-time market dynamics. This approach often results in static pricing that fails to adapt to fluctuating demand, leading to either overpriced tickets that remain unsold or undervalued tickets that do not optimize the seller's revenue.

Moreover, these conventional platforms typically lack detailed venue-specific information. Buyers often navigate through vague seat descriptions, unable to ascertain the precise location of their potential seats within the venue. This lack of detailed seating information hinders the buyer's decision-making process, leading to a less informed purchase.

The process of transaction on such platforms is often devoid of robust security measures, particularly in the financial aspects of ticket resale. This lack of secure transaction mechanisms raises concerns over the authenticity of tickets and the reliability of financial exchanges, thereby eroding trust in the system.

Additionally, existing platforms do not provide dynamic interfaces that could assist users in making informed decisions. For instance, the absence of a feature that shows the historical trend of ticket prices for specific events or sections within a venue limits the buyer's ability to gauge the market and make a value-based purchase. Sellers, on the other hand, are unable to adjust their prices in response to real-time market trends effectively.

Another significant limitation is the rigidity in the buying process. Prospective buyers are often constrained to choose from existing ticket listings without the ability to express their willingness to pay a specific price for tickets in a desired location or row. This limitation restricts the market's efficiency, as it does not fully capitalize on the potential of supply and demand dynamics.

These constraints within the current market underscore the need for an innovative approach to online ticket resale. A system that addresses these shortcomings by offering dynamic pricing reflecting real-time supply and demand, detailed and interactive venue seating maps, and secure transaction mechanisms would substantially enhance the ticket buying and selling experience. This need for a more refined, secure, and user-friendly platform forms the foundation upon which the novel invention is built, promising a transformative impact on the online ticket resale market.

It is within this context that the present invention is provided.

### SUMMARY

The present invention encompasses a method for managing the resale of event tickets through an online marketplace. The method involves operating one or more servers to manage an online platform that is accessible to users via networked computing devices. The platform is configured to render an interactive map of an event venue, segmenting the venue into multiple sections and subdividing those sections into rows.

In some embodiments, the method allows sellers to list event tickets for sale corresponding to specific rows within the sections at prices they desire. Buyers can access the platform and submit open offers to purchase tickets, specifying desired rows and including proposed prices and quantities, with no requirement for specific seat identification.

In some embodiments, a matching operation is performed when a buy offer matches a sell offer. The method includes facilitating secure financial transactions between buyers and sellers via an escrow service integrated into the online platform.

In some embodiments, the online platform provides mechanisms for both buyers and sellers to sort and filter listings and offers based on criteria such as price and ticket quantity. This facilitates the users' ability to find offers that meet their specific needs.

In some embodiments, the platform displays a detailed section map, which is separate from the general venue map, indicating available ticket offers in each row along with associated details. This allows users to make informed decisions based on the precise location of the tickets within the venue.

In some embodiments, the online platform includes a row market interface. This interface provides users with detailed information about buy and sell offers for specific rows, including the number of tickets per offer and a historical price trend analysis for those tickets.

In some embodiments, the platform features a time series chart that visualizes historical and real-time fluctuations in ticket prices for each row, providing users with information on market trends. This chart may include data on both high and low offers over a specified period, offering a comprehensive view of the market's pricing dynamics.

In some embodiments, the method allows sellers to adjust the listed prices of their tickets at any time prior to the completion of a sale, thus offering dynamic pricing capabilities within the online marketplace.

In some embodiments, buyers are enabled to submit offers for tickets in an entire section of the venue map, not just specific rows, broadening the scope of potential transactions.

In some embodiments, the method includes a feature allowing sellers to match their ticket listings directly with existing purchase offers made by buyers, facilitating immediate transaction opportunities.

In some embodiments, the interactive venue map distinguishes sections with sell offers, buy offers, or both, using distinct visual markers.

In some embodiments, the online platform incorporates a user interface for uploading and transferring PDF versions of tickets as part of the ticket listing and selling process.

In some embodiments, the method includes a feature allowing buyers to set expiration dates and times for their purchase offers, which remain invisible to other users.

In some embodiments, buyers can post multiple purchase offers for various rows and sections at different prices, with an automated system to cancel all other offers once a purchase is completed for a specified quantity of tickets.

In some embodiments, the buyers can also post general purchase offers for tickets within a specified price range within an entire venue for a specified event.

### BRIEF DESCRIPTION OF THE DRAWINGS

Various embodiments of the invention are disclosed in the following detailed description and accompanying drawings.

FIG. 1 depicts a process flowchart for an online marketplace, outlining the sequential steps from platform access to ticket transfer for the resale of event tickets, highlighting user interactions for both buyers and sellers.

FIG. 2 illustrates the network architecture of the online marketplace, showing the relationship between cloud-based servers, databases, and user devices, and detailing the data flow essential for marketplace operations.

FIG. 3A shows a user interface display providing an interactive venue map of the Charleston Battery stadium, where users can view event details and navigate ticket listings to facilitate the buying and selling process.

FIG. 3B focuses on a detailed section map within the online marketplace, displaying sell and buy offers for individual rows and allowing users to directly engage with the ticket resale market.

FIG. 3C presents the Row Market screen of the online marketplace, providing a time series chart of ticket pricing data to aid users in making informed decisions on ticket purchases based on market trends.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The terms “first,” “second,” and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

### DESCRIPTION OF DRAWINGS

The present disclosure relates to a system and method for managing the resale of event tickets through an online marketplace. The invention encompasses a computer-implemented platform designed to facilitate the buying and selling of event tickets. This platform operates via a server, accessible to users through network-connected computing devices, and offers an array of features to streamline the process of ticket resale.

Central to the invention is an interactive map of event venues, displayed on the online platform. This map is segmented into various sections and further subdivided into rows, enabling users to visualize the specific areas within a venue. Sellers, who are users with tickets to sell, can list their tickets on the platform, associating each ticket with a specific row within a section of the venue map. These tickets are listed at prices set by the sellers. Buyers, who are users looking to purchase tickets, can view these listings and submit offers to purchase tickets. Notably, the offers submitted by buyers do not require specific seat identification but are based on the desired row, along with proposed prices and quantities.

A feature of the invention is the integration of an escrow service within the platform, ensuring secure financial transactions between buyers and sellers. This service mitigates the risks commonly associated with online ticket sales, such as fraud and non-delivery. To assist users in navigating the platform, sorting and filtering mechanisms are provided, allowing both buyers and sellers to organize listings and offers based on various criteria, including price and ticket quantity.

Further enhancing the utility of the platform is the inclusion of a detailed section map, separate from the general venue map. This section map provides users with more granular information about available ticket offers in each row, including price and quantity details. Additionally, the platform features a time series chart that visualizes historical and real-time price fluctuations for tickets, offering valuable insights into market trends.

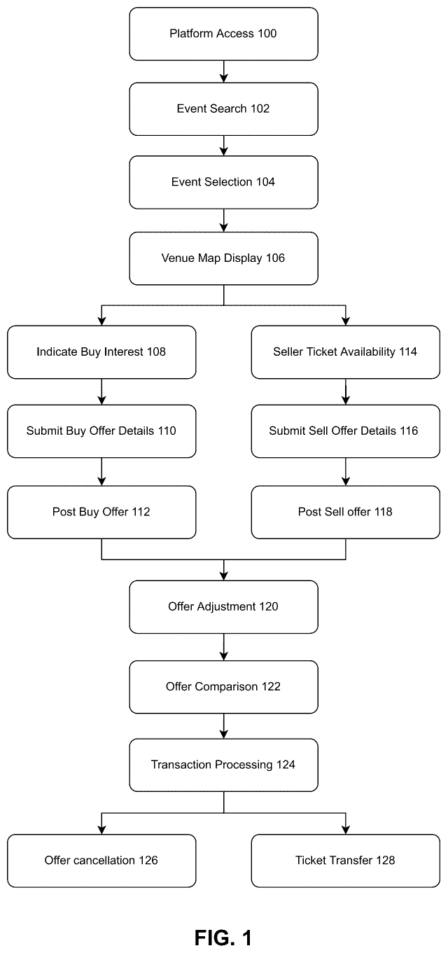

FIG. 1 illustrates a process flowchart for an online marketplace designed for the resale of event tickets.

The flowchart initiates with the step where customers open the platform, indicated as the platform access step 100. Upon accessing the platform, customers proceed to search for an event, represented as the event search step 102. This step allows users to identify their event of interest, which they can select based on various criteria such as date, venue, or location.

Subsequently, the customer finds the event date and venue, detailed as the event selection step 104, followed by opening the venue map, shown as the venue map display step 106. This interactive map is a visual representation of the venue, delineating the available sections and rows for ticket selection. The flowchart then divides into two paths: one for the buyer and one for the seller.

In the first path the user indicates interest in buying tickets 108. The system will ask the user to specify a quantity of tickets and a specified price, shown in the buyer offer detail step 110. The buyer then posts their offer(s) 112, which will be shown on the specified section maps within the venue map.

The seller path includes the decision step where the seller indicates they have tickets to sell for the selected event, denoted as the seller ticket availability step 114. The seller submits the price and quantity of the tickets, outlined in the sell offer details step 116, and posts the sell offer on the platform, as indicated in the submit sell offer 118.

Both buyers and sellers can view existing offers at all times. They also have the ability to adjust or cancel their offers at any time, as indicated in the offer adjustment step 120.

The platform continuously compares buy and sell offers, an operation depicted in the offer comparison step 122. When a price and quantity match is identified between a buyer's offer and a seller's listing, the platform processes the transaction via an escrow service, ensuring secure payment and ticket transfer, as shown in the transaction processing step 124.

If a buyer reaches the specified quantity of tickets, the platform will automatically cancel all other pending buy offers of theirs, if they have any, as illustrated in the offer cancellation step 126. Upon a successful match and transaction, the event tickets are transferred to the buyer, indicated in the ticket transfer step 128.

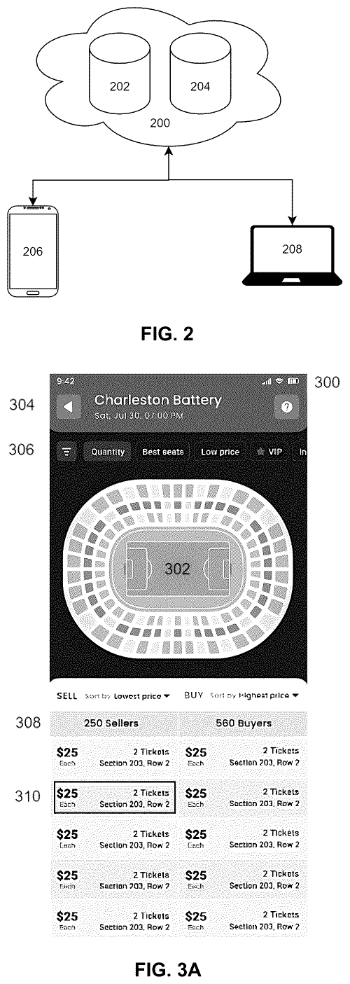

FIG. 2 exemplifies a network architecture for implementing the disclosed online marketplace for event ticket resale, incorporating a cloud network architecture 200.

Servers 202 operate within this architecture and are responsible for processing user requests, executing marketplace logic, and managing data transactions with databases 204. These databases are robust repositories that maintain critical information such as user profiles, each with identification and authentication data to ensure secure access; event details encompassing dates, times, and performer information; specific venue seating maps that enable the interactive venue map functionality; and comprehensive ticket listings, including prices, row and section information, and the status of each ticket listing.

The architecture interfaces with various user devices, such as first user device 206 and second user device 208. These devices may range from personal computers and laptops to smartphones and tablets, each equipped with the necessary software and network capabilities to interact with the online marketplace. The first user device 206, typically operated by buyers, is utilized to access the platform for functions such as viewing venue maps that are detailed to the level of individual seats, submitting offers for tickets, and completing financial transactions. The second user device 208, typically operated by sellers, is used to list tickets for sale, adjust ticket prices in response to market demand, and manage ticket listings, including confirming when a sale is finalized.

In the databases 204, specific venue seating maps are stored, which facilitate the rendering of the interactive venue map on the online platform. These maps are not only detailed to the level of individual seating rows and sections but also include indicators for different price points and the availability status of tickets. The databases further store transaction records that detail each step from the offer to the sale completion, including any adjustments to offers made by either buyers or sellers.

The system is designed to support a real-time matching engine that processes buy and sell offers, comparing them for matches based on the price and quantity parameters set by the users. The transaction processing is secured through an integrated escrow service, ensuring that the exchange of funds and tickets is completed only upon verified agreement between the buyer and seller.

It is to be understood that this is merely one example of a suitable system architecture for implementing the disclosed methods, and many other suitable configurations are possible.

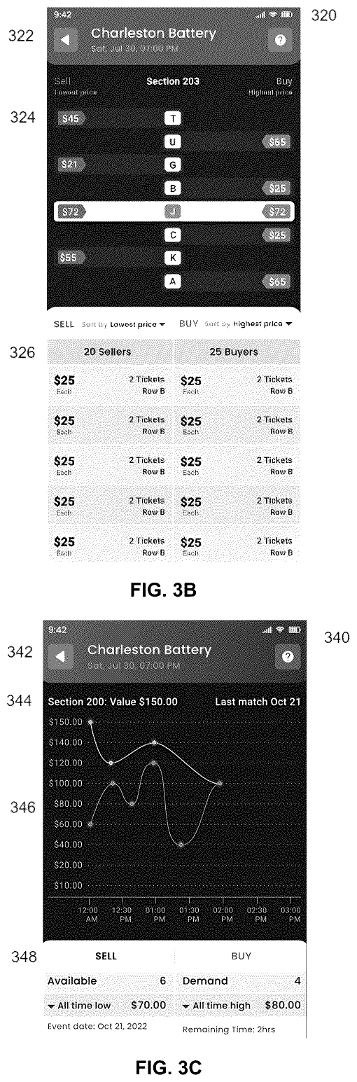

FIG. 3A illustrates a user interface display 300 of the online marketplace for the resale of event tickets as viewed on a user device. This example screen displays a venue map for a specific event at the Charleston Battery stadium. The display 300 includes an interactive venue map 302 at the center, which graphically represents the seating arrangement of the stadium and highlights the sections with available tickets for sale.

The top of the display 300 provides event details 304, including the name of the venue, the date, and time of the event. This is followed by a menu bar 306, offering various options for the user to refine their search for tickets based on criteria such as quantity, seat quality, price range, and additional amenities, exemplified by the VIP option.

Below the venue map 302, there are dual listing columns 308 for sellers and buyers. The seller column displays ticket listings with corresponding prices and the specific section and row where the tickets are located. Similarly, the buyer column shows current buyer offers, again detailing price and the desired section and row. Both columns include a sorting function, allowing sellers to arrange their listings by the lowest price and buyers to sort offers by the highest price, facilitating the process of matching supply with demand.

Each ticket listing and offer within the seller and buyer columns is accompanied by an indication of the number of tickets available or desired in specific venue sections and the respective price offer for those tickets 310, allowing users to quickly ascertain the volume of tickets in a particular offer.

The display 300 is designed to be user-friendly and intuitive, enabling users to navigate easily through the process of buying or selling tickets. The interface is structured to present all relevant information clearly and concisely, supporting users in making informed decisions regarding their transactions in the ticket resale marketplace.

FIG. 3B presents a second user interface display 320 of the online marketplace, this time focusing on a section map for a designated section within an event venue. This display provides detailed information on available tickets within a specific section of the venue, still in the Charleston Battery stadium in this example, identified here as Section 203.

At the top of the display 320, the event details 322 are provided, which include the venue name ‘Charleston Battery’, along with the date and time of the event. Immediately below the event details 322, the interface presents a list of the rows 324 in section 203 and the prices at which buy and sell tickets are present in each row, with the sell side sorted by the lowest price and the buy side sorted by the highest price. The rows may be color-coded based on whether buy and sell offers are available for each row. In the example, row T has a sell offer for $45 but no buy offers, row U has a buy offer for $65 but no sell offer, and row J, which has been highlighted in the interface, has both sell and buy offers for $72, which will likely lead to a match and transaction between the seller and buyer.

Below the section map is a sell and buy column area 326 similar to that of FIG. 3A, but which is limited to including offers specifically for the selection section 203.

The sell listing column shows individual sell offers with specified prices and the number of tickets available for each row within the section. Correspondingly, the buy listing column displays current buy offers, again detailing the offered prices and desired number of tickets for specific rows.

FIG. 3C portrays a third user interface display 340 for another feature within the online marketplace: the Row Market screen. This display 340 is designed to provide users with real-time data and historical data on ticket pricing within a specific section of an event venue, herein identified as Section 200.

The upper portion of the display 340 presents the event information 342, which includes the name of the venue, still “Charleston Battery,” along with the date and time of the event.

Below the event information is a value indicator 344 which provides the current value of tickets within the selected section.

The central feature of FIG. 3C is a time series chart 346 that delineates the variations in ticket prices over a specified time period. The chart 346 is plotted with data points connected by lines, each point representing a sale or offer match with indicators such as the last match point 348.

Below the time series chart, the display includes another pair of ‘SELL’ and ‘BUY’ columns 348 for viewing the pricing data are shown. The SELL section details the number of tickets available for sale, while the BUY section indicates the current demand for tickets, i.e. the number of buy offers in the section. Adjacent to these, indicators for all-time low and all-time high prices give a historical pricing context for the tickets in the section.

The Row Market screen is rich in information, but is designed for informational purposes only, meaning that users cannot directly buy or sell tickets from this screen. Instead, they must use this data to inform their transactions, which would be completed on other screens within the marketplace platform.

In addition to specific row markets and sections, buyers may be able to post generic purchase offers for tickets within a specified price range for an event for an entire venue.

### Network Components

As mentioned above, the disclosed method can be implemented by any suitable server architecture. A server as described herein can be any suitable type of computer. A computer may be a uniprocessor or multiprocessor machine. Accordingly, a computer may include one or more processors and, thus, the aforementioned computer system may also include one or more processors. Examples of processors include sequential state machines, microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), gated logic, programmable control boards (PCBs), and other suitable hardware configured to perform the various functionality described throughout this disclosure.

Additionally, the computer may include one or more memories. Accordingly, the aforementioned computer systems may include one or more memories. A memory may include a memory storage device or an addressable storage medium which may include, by way of example, random access memory (RAM), static random access memory (SRAM), dynamic random access memory (DRAM), electronically erasable programmable read-only memory (EEPROM), programmable read-only memory (PROM), erasable programmable read-only memory (EPROM), hard disks, floppy disks, laser disk players, digital video disks, compact disks, video tapes, audio tapes, magnetic recording tracks, magnetic tunnel junction (MTJ) memory, optical memory storage, quantum mechanical storage, electronic networks, and/or other devices or technologies used to store electronic content such as programs and data. In particular, the one or more memories may store computer executable instructions that, when executed by the one or more processors, cause the one or more processors to implement the procedures and techniques described herein. The one or more processors may be operably associated with the one or more memories so that the computer executable instructions can be provided to the one or more processors for execution. For example, the one or more processors may be operably associated to the one or more memories through one or more buses. Furthermore, the computer may possess or may be operably associated with input devices (e.g., a keyboard, a keypad, controller, a mouse, a microphone, a touch screen, a sensor) and output devices such as (e.g., a computer screen, printer, or a speaker).

The computer may advantageously be equipped with a network communication device such as a network interface card, a modem, or other network connection device suitable for connecting to one or more networks.

A computer may advantageously contain control logic, or program logic, or other substrate configuration representing data and instructions, which cause the computer to operate in a specific and predefined manner as, described herein. In particular, the computer programs, when executed, enable a control processor to perform and/or cause the performance of features of the present disclosure. The control logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro code, circuitry, data, and/or the like.

The control logic conventionally includes the manipulation of digital bits by the processor and the maintenance of these bits within memory storage devices resident in one or more of the memory storage devices. Such memory storage devices may impose a physical organization upon the collection of stored data bits, which are generally stored by specific electrical or magnetic storage cells.

The control logic generally performs a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, files, or the like. It should be kept in mind, however, that these and some other terms should be associated with appropriate physical quantities for computer operations, and that these terms are merely conventional labels applied to physical quantities that exist within and during operation of the computer based on designed relationships between these physical quantities and the symbolic values they represent.

It should be understood that manipulations within the computer are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general-purpose computing machines or devices may be used with programs constructed in accordance with some of the teachings described herein. In some embodiments, very specific computing machines, with specific functionality, may be required.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the system and related methods for ticket resale have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A method for managing the resale of event tickets through an online marketplace, the method comprising operating one or more servers to manage an online platform accessible to users via networked computing devices, and comprising the following steps:
rendering on the online platform an interactive map of an event venue, wherein said map is segmented into multiple sections and further subdivided into rows;
enabling a first group of users, identified as sellers, to list event tickets for sale corresponding to specific rows within said sections and at desired prices;
enabling a second group of users, identified as buyers, to access said online platform and submit offers to purchase said event tickets, wherein said offers specify desired rows and include proposed prices and quantities without requiring specific seat identification;
performing a matching operation when a buy offer matches a sell offer and facilitating secure financial transactions between said buyers and sellers via an escrow service integrated into the online platform.

2. The method of claim 1, further comprising: providing on the online platform mechanisms for both buyers and sellers to sort and filter listings and offers based on various criteria, including but not limited to price and ticket quantity.

3. The method of claim 1, further comprising: displaying a detailed section map within said online platform, separate from the general venue map, indicating available ticket offers in each row with associated details.

4. The method of claim 1, further including: a row market interface within the online platform, wherein users can view detailed information about buy and sell offers for specific rows, including the number of tickets per offer and a historical price trend analysis for those tickets.

5. The method of claim 1, further comprising: including a feature within the online platform to display a time series chart, which visualizes historical and real-time fluctuations in ticket prices for each row, thereby providing market trend information to the users.

6. The method of claim 5, wherein the time series chart includes data on both high and low offers over a specified period, providing a comprehensive view of the market's pricing dynamics.

7. The method of claim 1, further comprising: enabling the sellers to adjust the listed prices of their tickets at any time prior to the completion of a sale, providing dynamic pricing capabilities within the online marketplace.

8. The method of claim 1, wherein the buyers can submit offers for tickets in an entire section of the venue map, in addition to specific rows, thus broadening the scope of potential transactions.

9. The method of claim 1, further including: a feature that allows sellers to match their ticket listings directly with the existing purchase offers made by buyers, thereby facilitating immediate transaction opportunities.

10. The method of claim 1, wherein the interactive venue map highlights sections with both sell and buy offers, using distinct visual markers to differentiate between sections that have only sell offers, only buy offers, and those that have both.

11. The method of claim 1, wherein the online platform includes a user interface that allows users to upload and transfer PDF versions of the tickets as part of the ticket listing and selling process.

12. The method of claim 1, further comprising: a feature that allows buyers to set expiration dates and times for their purchase offers, with the provision that these expiration parameters are not visible to other users.

13. The method of claim 1, wherein the buyers can post multiple purchase offers for various rows and sections at different prices, with an automated system in place to cancel all other offers once a purchase is completed for a specified quantity of tickets.

14. The method of claim 1, wherein the buyers can also post general purchase offers for tickets within a specified price range within an entire venue for a specified event.
